(19) United States
(12) Patent Application Publication
(10) Pub. No.: US 2014/0262980 A1
(43) Pub. Date: Sep. 18, 2014

(54) SHEET PROCESSING METHOD AND SHEET PROCESSING SYSTEM

(71) Applicant: Kabushiki Kaisha Toshiba, Tokyo (JP)

(72) Inventor: Masashi Nakada, Kawasaki-shi (JP)

(73) Assignee: Kabushiki Kaisha Toshiba, Tokyo (JP)

(21) Appl. No.: 14/198,839

(22) Filed: Mar. 6, 2014

(30) Foreign Application Priority Data
Mar. 14, 2013 (JP) 2013-052172

(51) Int. Cl. B07C 5/34

(52) U.S. Cl. CPC B07C 5/34
USPC 209/583

(57) ABSTRACT

According to one embodiment, a sheet processing method in a sheet processing apparatus, the method includes, reading images of the sheets being conveyed, discriminating whether the sheets are exclusion pieces or not based on the images of the sheets, recognizing the identification information based on an image read from the batch card, storing an image read from deposit card while correlating this image with the identification information, sorting the sheets into collection storages based on discrimination results, and storing discrimination results while correlating these discrimination results with the identification information.

### CROSS-REFERENCE TO RELATED APPLICATIONS

This application is based upon and claims the benefit of priority from Japanese Patent Application No. 2013-052172, filed Mar. 14, 2013, the entire contents of which are incorporated herein by reference.

### FIELD

Embodiments described herein relate generally to a sheet processing method and sheet processing system.

### BACKGROUND

Conventionally, a sheet processing apparatus for, e.g., counting and discriminating sheets is in practical use. The sheet processing apparatus takes in sheets one by one from a loading module with the sheets loaded therein and transfers each sheet to a sheet inspection apparatus. The inspection apparatus performs various processes to the sheet to discriminate the sheet in terms of its category, fitness level, authentication, and so forth.

Further, in light of more efficient processing of counting results, the sheet processing apparatus processes batch cards each having an identification number printed thereon. The sheet processing apparatus can correlate counting results with the identification numbers of batch cards.

In order to correlate counting results with batch cards, it is necessary in advance to manually input the identification information of the batch cards, and the deposit information that shows, e.g., customers, account numbers, and amounts of money. Accordingly, there is a problem such that this inputting is troublesome.

### BRIEF DESCRIPTION OF THE DRAWINGS

FIG. 1 is an exemplary view for explaining a sheet processing system according to an embodiment.

FIG. 2 is an exemplary view for explaining a sheet processing apparatus according to the embodiment.

FIG. 3 is an exemplary view for explaining the sheet processing apparatus according to the embodiment.

FIG. 4 is an exemplary view for explaining the sheet processing apparatus according to the embodiment.

FIG. 5 is an exemplary view for explaining the sheet processing apparatus according to the embodiment.

FIG. 6 is an exemplary view for explaining a batch card according to the embodiment.

FIG. 7 is an exemplary view for explaining a deposit card according to the embodiment.

FIG. 8 is an exemplary view for explaining the sheet processing apparatus according to the embodiment.

### DETAILED DESCRIPTION

In general, according to one embodiment, a sheet processing method in a sheet processing apparatus, the method includes, taking in sheets one by one from a bundle of sheets, which includes a batch card having identification information, a deposit card printed with deposit information, and inspection object mediums, stacked each other, conveying the sheets thus taken in, reading images of the sheets being conveyed, discriminating whether the sheets are exclusion pieces or not based on the images of the sheets, recognizing the identification information based on an image read from the batch card, storing an image read from the deposit card while correlating this image with the identification information, sorting the sheets into collection storages based on discrimination results, and storing discrimination results while correlating these discrimination results with the identification information.

A sheet processing method and sheet processing system according to an embodiment will now be described in detail with reference to the accompanying drawings.

FIG. 1 shows an exemplary structure of a sheet processing system 1 according to an embodiment.

The sheet processing system 1 includes one or more sheet processing apparatuses 100 (at least one apparatus), a re-inspection apparatus 200, and a server 300. The sheet processing apparatuses 100, the re-inspection apparatus 200, and the server 300 are connected to each other via a network so that they can transmit and receive data between them.

Each of the sheet processing apparatuses 100 takes in a plurality of loaded sheets (inspection object mediums) one by one at a high speed, and inspects each of the sheets thus taken in about its category, fitness, and authentication. In addition, the sheet processing apparatus 100 counts the number of sheets. Then, the sheet processing apparatus 100 bands a bundle of reusable sheets thus inspected and discharges them.

Further, the sheet processing apparatus 100 judges whether each of the sheets requires re-inspection or not. The sheet processing apparatus 100 discharges sheets judged to require re-inspection, as exclusion pieces.

The sheet processing apparatus 100 processes a batch card and a deposit card put on the bundle of sheets. The batch card has its own specific identification information (ID) printed thereon in the form of a bar code, two-dimensional code, or other means. The sheet processing apparatus 100 can read the image of the batch card to recognize the identification information of the batch card. The batch card and the deposit card will be explained later.

The sheet processing apparatus 100 correlates the counting result of the sheets with the identification information of the batch card and thereby obtains an inspection result. The sheet processing apparatus 100 transmits the inspection result to the server 300.

Further, the sheet processing apparatus 100 discharges the batch card and the deposit card as exclusion pieces. Thus, the sheet processing apparatus 100 discharges, as exclusion pieces, sheets judged to require re-inspection along with the batch card and the deposit card in the form of a bundle of them.

The server 300 attaches an index to the inspection result transmitted from the sheet processing apparatus 100 and stores it in the storage medium of the server 300.

The exclusion pieces discharged from the sheet processing apparatus 100 are loaded into the re-inspection apparatus 200 by an operator who operates the sheet processing apparatus 100 and the re-inspection apparatus 200. The re-inspection apparatus 200 re-inspects the exclusion pieces thus loaded.

The re-inspection apparatus 200 correlates the counting result of the sheets with the identification information of the batch card and thereby obtains a re-inspection result. The re-inspection apparatus 200 transmits the re-inspection result thus correlated to the server 300.

The server 300 combines re-inspection results transmitted from the re-inspection apparatus 200 respectively with inspection results transmitted from the sheet processing apparatus 100, and stores the combined inspection results in the storage medium of the server 300. For example, the server 300 adds a re-inspection result to an inspection result where the identification information included in the re-inspection result agrees with the identification information of the inspection result.

FIG. 2 shows an external view of the sheet processing apparatus 100 according to the embodiment.

As shown in FIG. 2, the sheet processing apparatus 100 includes part of a loading module 112, an operation module 136, an operation display 137, a door 138, an outlet port 139, and a keyboard 140, which are all disposed outside the apparatus.

The loading module 112 is used to load the sheets P therein. The loading module 112 receives the sheets P collectively in a stacked state. As described above, the batch card and the deposit card are put on the bundle of sheets P.

The operation module 136 receives various operation inputs made by operators. The operation display 137 displays various operation guides and process results to operators. The operation display 137 may be formed of a touch panel. In this case, the sheet processing apparatus 100 detects various operation inputs based on buttons displayed on the operation display 137 and operations made by operators onto the operation display 137.

The door 138 is used as a door for opening and closing the load port of the loading module 112. The outlet port 139 is a module to take out sheets P from a collecting module that is used to stack sheets judged by the sheet processing apparatus 100 to be unsuitable for re-circulation. The keyboard 140 severs as an input module to receive various operation inputs made by operators.

FIG. 3 shows an exemplary structure of the sheet processing apparatus 100 shown in FIG. 2.

The sheet processing apparatus 100 includes part of the loading module 112, a taking-in module or pickup module 113, a suction roller 114, a conveyor path 115, an inspection module 116, gates 120 to 125, an exclusion conveyor path 126, an exclusion collecting module 127, collecting and banding modules 128 to 131, a cutting module 133, and a stacker 134, which are all disposed inside the apparatus. Further, the sheet processing apparatus 100 is equipped with a main controller 151. The main controller 151 integrally controls the operations of the respective components of the sheet processing apparatus 100.

The pickup module 113 is present above the loading module. The pickup module 113 includes a suction roller 114. The suction roller 114 is configured to come into contact with the upper end (in the stacking direction) of the sheets P set inside the loading module 112. Accordingly, the suction roller 114 rotates and thereby picks up the sheets P, set inside the loading module 112, one by one into the apparatus from the upper end in the stacking direction. For example, the suction roller 114 functions to pick up one of the sheets P by every one rotation. The suction roller 114 thereby takes in the sheets P with a constant pitch. Each of the sheets P thus taken in by the suction roller 114 is introduced into the conveyor path 115. The suction roller 114 may include a suction rotor that utilizes a suction force generated by, e.g., a vacuum pump to pick up each sheet while sucking its surface.

The conveyor path 115 is used to transfer the sheets P to the respective modules inside the sheet processing apparatus 100. The conveyor path 115 includes a conveyor belt, drive pulleys, and so forth, which are not shown. The conveyor path 115 operates the conveyor belt by use of a drive motor, which is not shown, and the drive pulleys. The conveyor path 115 uses the conveyor belt to convey at a constant speed each sheet P taken in by the suction roller 114. In this specification, the side of the conveyor path 115 close to the pickup module 113 is mentioned as an upstream side, and the side thereof close to the stacker 134 is mentioned as a downstream side.

The inspection module 116 is provided on the conveyor path 115 extending from the pickup module 113. The inspection module 116 includes an image reader 117, an image reader 118, and a thickness inspection module 119. The inspection module 116 detects the optical characteristic information, mechanical characteristic information, and magnetic characteristic information of each sheet P. The sheet processing apparatus 100 thereby detects the kind (category), fitness level, and authentication of the sheet P.

The image readers 117 and 118 are disposed to face each other with the conveyor path 115 interposed between them. The image readers 117 and 118 respectively read opposite sides of each sheet P conveyed through the conveyor path 115. Each of the image readers 117 and 118 includes an array of light receiving devices, such as charge coupled devices (CCD) or complimentary metal oxide semiconductor (CMOS) devices, along with an optical system. The light receiving devices convert received light into an electrical signal, i.e., an image. The optical system includes a component, such as a lens or light guide member, which receives light and forms an image from the received light on the light receiving devices.

The sheet processing apparatus 100 obtains pattern images on the front side and back side of each sheet P based on the images taken by the image readers 117 and 118. Further, the image readers 117 and 118 take an image including identification information printed on each batch card and transmit the image (batch card image) thus taken to the main controller 151. Further, the image readers 117 and 118 take an image on the ticket face of each deposit card and transmit the image (deposit card image) thus taken to the main controller 151.

Images read by the image readers 117 and 118 are temporarily stored in a memory, which is not shown, inside the inspection module 116. The sheet processing apparatus 100 can cause the operation display 137 to display each of the images stored in this memory in accordance with an operation input.

The thickness inspection module 119 inspects the thickness of each sheet P conveyed through the conveyor path 115. For example, if a detected thickness is not less than a predetermined value, the sheet processing apparatus 100 detects a situation where two sheets P have been picked up in an overlapping state.

Further, the inspection module 116 includes a magnetic sensor or the like, which is not shown. The magnetic sensor detects the magnetic characteristic information of each sheet P.

The main controller 151 performs various kinds of discrimination based on detection results obtained by the image readers 117 and 118, the thickness inspection module 119, the magnetic sensor, and so forth. For example, the main controller 151 determines the denomination or category of each sheet P.

Further, the main controller 151 determines the authentication of each sheet P. Specifically, the main controller 151 determines whether the sheet P is genuine or counterfeit.

Further, the main controller 151 detects the fitness of each sheet P. Specifically, the main controller 151 determines whether the sheet P is a fit sheet suitable for re-circulation or an unfit sheet unsuitable for re-circulation.

Further, the main controller 151 determines whether each sheet P is an exclusion piece or not. Specifically, the main controller 151 determines those sheets P as exclusion pieces, which are a sheet P that has been determined as a counterfeit, sheets P that have been detected by the thickness inspection module 119 as overlapping with each other, or a sheet P that has not been discriminable. In this respect, for example, the main controller 151 determines the batch card and the deposit card as exclusion pieces.

Further, the main controller 151 determines those sheets P as exclusion pieces, which are a set of a preceding sheet P and a succeeding sheet P that have caused a short pitch hindering them from being correctly detected by the respective detectors because they have been separated from each other by a short distance inside the conveyor path.

The sheet processing apparatus 100 transfers each sheet P determined as a fit sheet to the collecting and banding modules 128 to 131. Further, the sheet processing apparatus 100 transfers each sheet P determined as an unfit sheet to the cutting module 133. The cutting module 133 cuts the unfit sheet thus transferred. The sheet processing apparatus 100 may transfer each unfit sheet to the stacker 134 to collect unfit sheets. For example, the stacker 134 seals the unfit sheets thus collected, every time their number reaches, e.g., one hundred.

The sheet processing apparatus 100 transfers each sheet P determined as an exclusion piece to the exclusion collecting module 127. The exclusion pieces includes, for example, sheets that have been abnormally conveyed, such as two sheets P picked up in an overlapping state, defective sheets including parts folded or broken, and sheets that have not been discriminable, such as an inapplicable category or counterfeit. Further, the sheet processing apparatus 100 transfers sheets P along with the batch card and the deposit card inserted between the sheets P, as exclusion pieces, to the exclusion collecting module 127.

The gates 120 to 125 are provided in this order on the conveyor path 115 on the downstream side of the inspection module 116. Each of the gates 120 to 125 is controlled by the main controller 151. The main controller 151 controls the operation of each of the gates 120 to 125 based on an inspection result obtained by the inspection module 116. With this structure, the main controller 151 performs control to transfer the sheets P, which are conveyed through the conveyor path 115, to predetermined processors.

The gate 120 provided immediately after the inspection module 116 branches the conveyor path 115 to the exclusion conveyor path 126. Specifically, the gate 120 can be switched to transfer, to the exclusion conveyor path 126, an exclusion piece that has been determined to be not genuine as a result of inspection by the inspection module 116 or a non-inspectable sheet that has been unable to be inspected by the inspection module 116.

An exclusion collecting module (exclusion module) 127 is provided at the end of the exclusion conveyor path 126. The exclusion collecting module 127 collects exclusion pieces and non-inspectable sheets as described above without changing the states of the sheets picked up by the pickup module 113. The sheets P collected in the exclusion collecting module 127 can be taken out through the outlet port 139.

Further, the collecting and banding modules 128 to 131 (which will be collectively referred to as a collecting and banding module 132) are respectively provided at branches from the gates 121 to 124. The collecting and banding module 132 collects sheets P determined to be suitable for re-circulation, while sorting them in accordance with the category and the front and rear sides. The collecting and banding module 132 bands and stores collected sheets P as each bundle of a predetermined number of sheets.

The cutting module 133 is provided at a branch from the gate 125. The cutting module 133 cuts and stores sheets P. The sheets P transferred to the gate 125 are sheets P determined to be unsuitable for re-circulation (unfit sheets), although they are regular sheets P.

Further, the stacker 134 is provided at the end of another conveyor path branched from the gate 125. When an unfit sheet cutting mode is selected, the main controller 151 controls the gate 125 to transfer sheets P to the cutting module 133. When the unfit sheet cutting mode is not selected, the main controller 151 controls the gate 125 to transfer sheets P to the stacker 134.

Operators can operate the operation module 136, the operation display 137, and the keyboard 140 to arbitrarily set the kind (category) of sheets P to be processed by the sheet processing apparatus 100.

FIG. 4 shows an exemplary structure of the control system of the sheet processing apparatus 100 shown in FIGS. 2 and 3.

The sheet processing apparatus 100 includes the main controller 151, the inspection module 116, a conveyance controller 152, a cutting controller 156, the operation display 137, the keyboard 140, and so forth. Further, the sheet processing apparatus 100 includes a printer 141, a USB hub 161, a transport controller 162, a bander controller 163, and a detection controller 164.

The main controller 151 conducts overall control of the sheet processing apparatus 100. The main controller 151 can be implemented by, for example, a part of a PC (personal computer). The main controller 151 controls the conveyance controller 152 and the cutting controller 156 based on operations input via the operation display 137 and inspection results obtained by the inspection module 116. Further, the main controller 151 can output inspection results and so forth as records on slips by the printer 141.

The USB hub 161 is connected to the main controller 151. The USB hub 161 is also connected to the transport controller 162, the bander controller 163, and the detection controller 164.

The main controller 151 can control the operations of the conveyance controller 152, the cutting controller 156, and the pickup module 113 via the transport controller 162. Further, the main controller 151 can control the operations of the collecting and banding modules 128 to 131 via the bander controller 163. Further, the main controller 151 can control the operations of the respective detecting devices of the inspection module 116 via the detection controller 164.

For example, operators use the operation display 137 or the keyboard 140 to input a threshold for each of the processing items in various determinations for sheets P to be processed and to input a processing method.

The inspection module 116 includes the image readers 117 and 118, the thickness inspection module 119, and so forth, as described above.

The conveyance controller 152 controls the pickup module 113, the conveyor path 115, the exclusion conveyor path 126, and the gates 120 to 125 under the control of the main controller 151. The conveyance controller 152 thereby controls the taking-in and conveying of sheets P. Further, the conveyance controller 152 performs a sorting process of sorting determined sheets P in accordance with their categories. Thus, the conveyance controller 152 functions as a sorting processor.

For example, the conveyance controller 152 controls the gates 120 to 125 to transfer sheets P determined as unfit sheets to the cutting module 133 or the stacker 134. Further, the conveyance controller 152 controls the gates 120 to 125 to transfer sheets P determined as exclusion pieces, along with the batch card and the deposit card, to the exclusion collecting module 127.

The bander controller 163 controls the exclusion collecting module 127 and the collecting and banding modules 128 to 131 under the control of the main controller 151. The bander controller 163 thereby controls the collection and bundle-banding of sheets P.

The cutting controller 156 controls the operation of the cutting module 133 under the control of the main controller 151. The cutting module 133 thereby cuts sheets P transferred therein.

The main controller 151 can recognize the identification information of the batch card based on an image of the identification information of the batch card obtained by the image readers 117 and 118.

In this respect, the main controller 151 correlates the counting result of sheets P transferred to the collecting and banding module 132 or the cutting module 133 with the identification information of the batch card and stores them as an inspection result. Further, the main controller 151 transmits the inspection result to the server 300.

The main controller 151 includes a memory 151a for storing a threshold in advance for each of the inspection items performed by the respective inspection devices of the inspection module 116. The main controller 151 compares detection values detected by the respective inspection devices of the inspection module 116 with thresholds stored in the memory 151a, and, based on the comparison results, it determines the category, authentication, and fitness of each sheet P and also determines whether the sheet P is an exclusion piece or not.

The thresholds stored in the memory 151a may be changed in accordance with inputs to the operation module 136, the operation display 137, and the keyboard 140.

Further, the main controller 151 includes a memory 151b for storing the image of the deposit card read by the image readers 117 and 118 of the inspection module 116 and the identification information of the batch card while correlating them with each other. In this respect, the main controller 151 may be designed to use the memory 151b to store the identification information of the batch card, the image of the batch card, the image of the deposit card, and the inspection result while correlating them with each other. Alternatively, the main controller 151 may be designed to transmit to the server 300 the inspection result along with the identification information of the batch card and the image of the batch card while correlating them with each other.

FIGS. 5 to 7 show an example of a bundle including a batch card, a deposit card, and sheets P. FIG. 5 shows an example of the bundle 55 of sheets P. FIG. 6 shows an example of the batch card 53. FIG. 7 shows an example of the deposit card 54.

As shown in FIG. 5, the bundle 55 of sheets P comprises a predetermined number of sheets P (such as 1,000 sheets), the batch card 53, and the deposit card 54 stacked one on top of the other. For example, the bundle 55 of sheets P is formed such that the sheets P are sandwiched between the batch card 53 and the deposit card 54. Specifically, the batch card 53, the predetermined number of sheets P (such as 1,000 sheets), and the deposit card 54 are set in this order from above to form the bundle 55 of sheets P.

The batch card 53 is a sheet that has a contour size the same as each sheet P or a contour size larger than each sheet P and is printed with modules showing identification information on the front side or back side. As shown in FIG. 6, the batch card 53 includes printed modules, such as a bar code 531 of the identification information encoded and a letter string 532 denoting the identification information. The main controller 151 of the sheet processing apparatus 100 can obtain the identification information of the batch card 53 by analyzing the bar code 531 or the letter string 532 included in the image of the batch card. In this respect, the identification information of the batch card 53 is not limited to such a form of bar code but may be in the form of a two-dimensional code or another printed module encoded by use of another method. The batch card 53 is printed with a pattern that allows the sheet processing apparatus 100 or the re-inspection apparatus 200 to identify the batch card 53.

The deposit card 54 is a sheet that has a contour size the same as each sheet P or a contour size larger than each sheet P and is printed with modules showing deposit information on the front side or back side. As shown in FIG. 7, the deposit card 54 includes a printed module 541 showing deposit information including a letter string denoting a customer, a number denoting the customer, information indicating a date, the name of a staff forming the bundle 55, and information indicating an amount of money. The main controller 151 of the sheet processing apparatus 100 stores the deposit image in the memory 151b. Further, the main controller 151 reads the deposit image from the memory 151b and causes the operation display 137 to display it, when a preset condition is applicable. The sheet processing apparatus 100 thereby allows an operator to recognize the deposit information described on the deposit card 54. The deposit card 54 has a ticket face that is easy to visually distinguish it from the sheets P. In this respect, for example, the deposit card 54 may be printed with a pattern that allows the sheet processing apparatus 100 or the re-inspection apparatus 200 to identify the deposit card 54.

FIG. 8 shows an example of processes performed by the sheet processing apparatus 100.

The sheet processing apparatus 100 downloads processing schedule information in advance from the server 300 for the processing schedule of each processing unit (which will be referred to as a shift, hereinafter). The process information includes information indicating a customer and information indicating the total number of sheets P included in the shift. In this respect, a plurality of bundles 55 of sheets P may be included in the shift.

An operator activates the sheet processing apparatus 100 and performs various setting operations. The operator sets a bundle 55 in the loading module 112 of the sheet processing apparatus 100 and uses the operation display 137 to start the process.

When the process is started, the sheet processing apparatus 100 takes in the sheets P one by one (step S11). The sheet processing apparatus 100 thereby transfers each sheet P to the inspection module 116. The sheet processing apparatus 100 obtains the image of the sheet P by the image readers 117 and 118 of the inspection module 116 (step S12).

The bundle 55 includes a batch card 53 and a deposit card 54 put thereon. The operator sets the bundle 55 such that the batch card 53 is first taken in to the sheet processing apparatus 100. Thus, the sheet processing apparatus 100 first obtains the batch card image of the batch card 53.

The sheet processing apparatus 100 performs a discrimination process based on information detected by the inspection module 116 (step S13). At first, the sheet processing apparatus 100 performs a discrimination process based on the batch card image. In this case, the sheet processing apparatus 100 determines that the batch card 53 is an exclusion piece.

The sheet processing apparatus 100 performs a sorting process based on the result of the discrimination process (step S14). The sheet processing apparatus 100 transfers the batch card 53 determined as an exclusion piece to the exclusion collecting module 127.

The sheet processing apparatus 100 judges whether a succeeding sheet P is present or not (step S15). If the sheet processing apparatus 100 judges that a succeeding sheet P is present, it moves to the step S11 and processes the succeeding sheet P.

When the bundle 55 is processed, the sheet processing apparatus 100 processes the sheets P succeeding to the batch card 53. In this case, the sheet processing apparatus 100 discriminates the sheet P in terms of the authentication, fitness, and category based on an image read from the sheet P. Further, the sheet processing apparatus 100 sorts the sheets P into collection storages in accordance with discrimination results. For example, the sheet processing apparatus 100 determines those sheets P as exclusion pieces, which are a sheet P that has been determined as a counterfeit, sheets P that have been detected by the thickness inspection module 119 as overlapping with each other, or a sheet P that has not been discriminable. The sheet processing apparatus 100 transfers sheets P determined as exclusion pieces to the exclusion collecting module 127.

In a case where the batch card 53 and the deposit card 54 are put on the sheets P as in the bundle 55, the sheet processing apparatus 100 processes the deposit card 54 at the end. In this case, the sheet processing apparatus 100 obtains the deposit card image of the deposit card 54 at the end.

The sheet processing apparatus 100 performs a discrimination process based on the deposit card image. In this case, the sheet processing apparatus 100 determines that the deposit card 54 is an exclusion piece. The sheet processing apparatus 100 transfers the deposit card 54 determined as an exclusion piece to the exclusion collecting module 127.

As a result, exclusion pieces (exclusion piece bundle) are collected in the exclusion collecting module 127, in the order of the batch card 53, sheets P determined as exclusion pieces, and the deposit card 54.

If the sheet processing apparatus 100 judges in the step S15 that a succeeding sheet P is no present, it correlates the identification information read from the batch card 53 with the counting result of sheets P and thereby obtains an inspection result. The sheet processing apparatus 100 transmits the inspection result to the server 300.

The main controller 151 of the sheet processing apparatus 100 respectively correlates deposit card images and counting results with the identification information of batch cards and stores them in the memory 151b. For example, when the main controller 151 identifies the deposit card 54, it correlates the deposit card image and the counting result with the identification information of the batch card and stores them in the memory 151b. In this respect, for example, the main controller 151 may be designed to correlate the image of a sheet determined as an exclusion piece with the identification information of the batch card and stores them in the memory 151b.

The operator confirms the exclusion piece bundle, and further confirms sheets P included in the exclusion piece bundle. The operator confirms the number of genuine sheets included in the exclusion piece bundle, and uses the operation display 137 to input the number of genuine sheets. The sheet processing apparatus 100 thereby obtains a counting result, which is the total of the number of sheets P mechanically counted and the number of sheets P confirmed by the operator.

The sheet processing apparatus 100 correlates the number of sheets thus input with the identification information of the batch card 53 and transmits them to the server 300. The server 300 thereby obtains the counting result, which is the total of the number of sheets P mechanically counted and the number of sheets P confirmed by the operator.

The server 300 judges whether the inspection result is correct or not (step S16). For example, the server 300 judges whether the number of sheets P confirmed to be genuine agrees with a predetermined number or not.

If the number of sheets P confirmed to be genuine agrees with the predetermined number, the server 300 judges that the inspection result is correct. In this case, the server 300 transmits information indicating normal ending to the sheet processing apparatus 100. The sheet processing apparatus 100 causes the operation display 137 to display such information that the inspection has normally ended (step S17), and completes the process.

On the other hand, if the number of sheets P confirmed to be genuine does not agree with the predetermined number, the server 300 judges that the inspection result is abnormal. In this case, the server 300 transmits information indicating the occurrence of abnormality to the sheet processing apparatus 100. The sheet processing apparatus 100 causes the operation display 137 to display the information indicating the occurrence of abnormality (step S18).

If the number of sheets P confirmed to be genuine does not agree with the predetermined number, there may be a problem such that a counterfeit is mixed in the bundle 55 or the number of sheets P in the bundle 55 has been excess or short. In this case, the server 300 and the sheet processing apparatus 100 notify the operator of the presence of this problem. When the sheet processing apparatus 100 is notified of information indicating the occurrence of abnormality from the server 300, it causes the operation display 137 to display the deposit card image obtained from the deposit card 54 and an input screen picture for inputting deposit information. The sheet processing apparatus 100 can thereby urge the operator to input the deposit information.

Further, the sheet processing apparatus 100 correlates the identification information of the batch card 53 and the counting result with the input deposit information, and thereby creates a maintenance report. The sheet processing apparatus 100 transmits the maintenance report to the server 300. The server 300 can add the deposit information to the inspection result based on the maintenance report.

The sheet processing apparatus 100 may be designed to temporarily lock the operations and the collection storages when it is notified of information indicating the occurrence of abnormality from the server 300. Further, the sheet processing apparatus 100 may be designed to cause the printer 141 to print the maintenance report. After the sheet processing apparatus 100 processes all of the bundles 55 in one shift, it erases together the inspection results and the processing schedule information in the shift.

The main controller 151 of the sheet processing apparatus 100 can retrieve count information and the image of a deposit card 54 based on the identification information of a batch card 53. Specifically, the main controller 151 searches the memory 151b by use of the identification information of the batch card 53 as a key, and retrieves a counting result and a deposit card image that are correlated with the same identification information.

The sheet processing system 1 may be designed to process the exclusion piece bundle by the re-inspection apparatus 200. In this case, an operator activates the re-inspection apparatus 200 and performs various setting operations. The operator loads the exclusion piece bundle to the re-inspection apparatus 200 and starts a re-inspection process.

When the process is started, the re-inspection apparatus 200 takes in the sheets P one by one. The re-inspection apparatus 200 thereby transfers each sheet P to the inspection module (not shown) of the re-inspection apparatus 200. The re-inspection apparatus 200 obtains the image of the sheet P by an inspection module image reader.

The exclusion piece bundle includes the batch card 53 and the deposit card 54 put thereon. The operator sets the exclusion piece bundle such that the batch card 53 is first taken in to the re-inspection apparatus 200. Thus, the re-inspection apparatus 200 processes the batch card 53, sheets P excluded by the sheet processing apparatus 100, and the deposit card 54 in this order.

The re-inspection apparatus 200 performs a discrimination process based on information detected by the inspection module. The re-inspection apparatus 200 thereby discriminates the sheet P in terms of the authentication, fitness, and category. Further, the re-inspection apparatus 200 sorts the sheets P into collection storages in accordance with discrimination results. For example, the re-inspection apparatus 200 determines those sheets P as exclusion pieces, which are a sheet P that has been determined as a counterfeit, sheets P that have been detected by a thickness inspection module 119 as overlapping with each other, or a sheet P that has not been discriminable. The re-inspection apparatus 200 transfers sheets P determined as exclusion pieces to an exclusion collecting module (not shown).

In a case where the exclusion piece bundle is processed, the re-inspection apparatus 200 processes the deposit card 54 at the end. In this case, the re-inspection apparatus 200 obtains the deposit card image of the deposit card 54 at the end.

The re-inspection apparatus 200 determines that the deposit card 54 is an exclusion piece. The re-inspection apparatus 200 transfers the deposit card 54 determined as an exclusion piece to the exclusion collecting module.

If the re-inspection apparatus 200 judges that a succeeding sheet P is no present, it correlates the identification information read from the batch card 53 with the counting result of sheets P and thereby obtains a re-inspection result. The re-inspection apparatus 200 transmits the re-inspection result to the server 300.

The operator of the re-inspection apparatus 200 confirms the exclusion piece bundle, and further confirms sheets P included in the exclusion piece bundle. The operator confirms the number of genuine sheets included in the exclusion piece bundle, and inputs it into the re-inspection apparatus 200. The sheet re-inspection apparatus 200 thereby obtains a counting result, which is the total of the number of sheets P mechanically counted and the number of sheets P confirmed by the operator.

The re-inspection apparatus 200 correlates the number of sheets thus input with the identification information of the batch card 53 and transmits them to the server 300. The server 300 thereby obtains the counting result, which is the total of the number of sheets P mechanically counted and the number of sheets P confirmed by the operator.

The re-inspection apparatus 200 respectively correlates deposit card images and counting results with the identification information of batch cards and stores them in a storage module (not shown). For example, when the re-inspection apparatus 200 identifies the deposit card 54, it correlates the deposit card image and the counting result with the identification information of the batch card, and stores them in the storage module. In this respect, for example, the re-inspection apparatus 200 may be designed to correlate the image of a sheet determined as an exclusion piece with the identification information of the batch card and stores them in the storage module.

The server 300 combines re-inspection results transmitted from the re-inspection apparatus 200 respectively with inspection results transmitted from the sheet processing apparatus 100, and stores the combined inspection results in a storage medium inside the server 300. For example, the server 300 adds a re-inspection result to an inspection result where the identification information of the re-inspection result agrees with the identification information of the inspection result. The server 300 thereby calculates the total of the number of sheets P discriminated to be genuine (including fit sheets and unfit sheets) by the sheet processing apparatus 100 or the re-inspection apparatus 200 and the number of sheets P confirmed to be genuine by the operator.

The server 300 judges whether the inspection result is correct or not. For example, the server 300 judges whether the number of sheets P confirmed to be genuine agrees with a predetermined number or not.

If the number of sheets P confirmed to be genuine agrees with the predetermined number, the server 300 judges that the inspection result is correct. In this case, the server 300 transmits information indicating normal ending to the re-inspection apparatus 200. The re-inspection apparatus 200 causes a display module (not shown) to display such information that the inspection has normally ended, and completes the process.

On the other hand, if the number of sheets P confirmed to be genuine does not agree with a predetermined number, the server 300 judges that the inspection result is abnormal. In this case, the server 300 transmits information indicating the occurrence of abnormality to the re-inspection apparatus 200. The re-inspection apparatus 200 causes the display module to display the information indicating the occurrence of abnormality.

If the number of sheets P confirmed to be genuine does not agree with a predetermined number, there may be a problem such that a counterfeit is mixed in the bundle 55 or the number of sheets P in the bundle 55 has been excess or short. In this case, the server 300 and the re-inspection apparatus 200 notify the operator of the presence of this problem. When the re-inspection apparatus 200 is notified of information indicating the occurrence of abnormality from the server 300, it causes the display module to display the deposit card image obtained from the deposit card 54 and an input screen picture for inputting deposit information. The re-inspection apparatus 200 can thereby urge the operator to input the deposit information.

Further, the re-inspection apparatus 200 correlates the identification information of the batch card 53 and the counting result with the input deposit information, and thereby creates a maintenance report. The re-inspection apparatus 200 transmits the maintenance report to the server 300. The server 300 can add the deposit information to the inspection result based on the maintenance report.

The re-inspection apparatus 200 may be designed to temporarily lock the operations and the collection storages when it is notified of information indicating the occurrence of abnormality from the server 300. Further, the re-inspection apparatus 200 may be designed to cause a printer (not shown) to print the maintenance report.

The re-inspection apparatus 200 can retrieve count information and the image of a deposit card 54 based on the identification information of a batch card 53. Specifically, the re-inspection apparatus 200 searches the storage module by use of the identification information of the batch card 53 as a key, and retrieves a counting result and a deposit card image that are correlated with the same identification information.

In a case where the server 300 unitarily manages the inspection results, the identification information of the batch cards 53, and the deposit card images, the sheet processing apparatus 100 and the re-inspection apparatus 200 transmit the identification information of the batch cards 53 to the server 300. When the server 300 receives the identification information of a batch card 53, it searches the storage medium by use of the identification information as a key, and retrieves an inspection result and a deposit card image that are correlated with the same identification information. The server 300 transmits the inspection result and the deposit card image thus retrieved to the sheet processing apparatus 100 or the re-inspection apparatus 200.

As described above, the sheet processing apparatus 100 and the re-inspection apparatus 200 of the sheet processing system 1 process a bundle 55 of sheets P including a batch card 53 and a deposit card 54 with sheets P sandwiched between them. Further, the sheet processing apparatus 100 and the re-inspection apparatus 200 exclude the batch card 53, sheets P determined as exclusion pieces, and the deposit card 54 in a stacked state. Thus, when a problem arises, the sheet processing apparatus 100 and the re-inspection apparatus 200 can collect sheets along with the deposit card 54 and the batch card 53 put thereon. Consequently, even if the problem arises, there is no need for the operator to find the deposit card 54.

Further, the sheet processing apparatus 100 and the re-inspection apparatus 200 store the identification information of batch cards 53, deposit card images, and counting results, while correlating them with each other. Thus, the sheet processing apparatus 100 and the re-inspection apparatus 200 can retrieve a counting result and a deposit card image by use of the identification information of a batch card 53 as a key. The sheet processing apparatus 100 and the re-inspection apparatus 200 can hold the deposit card image as the evidence of the problem.

Further, when a problem arises, the sheet processing apparatus 100 and the re-inspection apparatus 200 display the deposit card image along with a screen picture for inputting deposit information to urge input of the deposit information. Consequently, there is no need to input the deposit information of all of the bundles 55 in the shift. The sheet processing apparatus 100 and the re-inspection apparatus 200 can thereby save the troublesome of manually inputting the deposit information.

As a result, there is provided a sheet processing method and sheet processing system that can efficiently process sheets.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sheet processing method in a sheet processing apparatus, the method comprising:
taking in sheets one by one from a bundle of sheets, which includes a batch card having identification information, a deposit card printed with deposit information, and inspection object mediums, stacked each other;
conveying the sheets thus taken in;
reading images of the sheets being conveyed;
discriminating whether the sheets are exclusion pieces or not based on the images of the sheets;
recognizing the identification information based on an image read from the batch card;
storing an image read from the deposit card while correlating this image with the identification information;
sorting the sheets into collection storages based on discrimination results; and
storing discrimination results while correlating these discrimination results with the identification information.

2. The sheet processing method according to claim 1, wherein the method comprises collecting the batch card, the deposit card, and those of the sheets discriminated as exclusion pieces, in a stacked state.

3. The sheet processing method according to claim 1, wherein the method comprises judging whether discrimination results are normal or not, and, if judging that a discrimination result is abnormal, notifying information for urging input of the deposit information printed on the deposit card.

4. A sheet processing method in a sheet processing apparatus, the method comprising:
taking in sheets one by one from a bundle of sheets, which includes a batch card having identification information, a deposit card printed with deposit information, and inspection object mediums, stacked each other;
conveying the sheets thus taken in;
reading images of the sheets being conveyed;
discriminating whether the sheets are exclusion pieces or not based on the images of the sheets;
recognizing the identification information based on an image read from the batch card;
sorting the sheets into collection storages based on discrimination results; and
storing discrimination results while correlating these discrimination results with the identification information.

5. The sheet processing method according to claim 4, wherein the method comprises collecting the batch card, the deposit card, and those of the sheets discriminated as exclusion pieces, in a stacked state.

6. The sheet processing method according to claim 4, wherein the method comprises judging whether discrimination results are normal or not, and, if judging that a discrimination result is abnormal, notifying information for urging input of the deposit information printed on the deposit card.

7. A sheet processing apparatus comprising:
a taking-in module configured to take in sheets one by one from a bundle of sheets, which includes a batch card having identification information, a deposit card printed with deposit information, and inspection object mediums, stacked each other;
a conveyor configured to convey the sheets thus taken in;
an image reader configured to read images of the sheets being conveyed;
a discriminating module configured to discriminate whether the sheets are exclusion pieces or not based on the images of the sheets;
a recognizing module configured to recognize the identification information based on an image read from the batch card;
a first storage module configured to store an image read from the deposit card while correlating this image with the identification information;
a sorting processor configured to sort the sheets into collection storages based on discrimination results; and
a second storage module configured to store discrimination results while correlating these discrimination results with the identification information.

8. The sheet processing system according to claim 7, wherein the system is configured to collect the batch card, the deposit card, and those of the sheets discriminated as exclusion pieces, in a stacked state.

9. The sheet processing system according to claim 7, wherein the system is configured to judge whether discrimination results are normal or not, and, if judging that a discrimination result is abnormal, to notify information for urging input of the deposit information printed on the deposit card.
